(19) United States
(12) Patent Application Publication
(10) Pub. No.: US 2013/0119163 A1
(43) Pub. Date: May 16, 2013

(54) TELESCOPING WATER JET DEVICE AND DRIVE ASSEMBLY

(71) Applicant: Shanghai Kohler Electronics,Ltd., Shanghai (CN)

(72) Inventors: Baian Xie, Shanghai (CN); Qifeng Kuang, Shanghai (CN); Hongchang Huang, Shanghai (CN)

(73) Assignee: Shanghai Kohler Electronics,Ltd., Shanghai (CN)

(21) Appl. No.: 13/677,026

(22) Filed: Nov. 14, 2012

(30) Foreign Application Priority Data
Nov. 15, 2011 (CN) 201110361857.2

(51) Int. Cl. B05B 15/10; H02K 7/114

(52) U.S. Cl. CPC B05B 15/10; H02K 7/114
USPC 239/548; 29/428; 310/83

(57) ABSTRACT

The invention provides a drive assembly for a telescoping wand of water jet device. The drive assembly includes an internally engaged rotary disk. With rotation of the internally engaged rotary disk, the telescoping wand of the water jet device is caused to retract or expand.

### CROSS-REFERENCE TO RELATED APPLICATIONS

The present application claims the benefit of and priority to Chinese Patent Application 201110361857.2, filed Nov. 15, 2011, the entire contents of which are hereby incorporated by reference in their entirety.

### BACKGROUND

The present disclosure relates generally to the field of telescoping water jet devices (e.g., telescoping or moving bidet wands) for use with sanitary or bath products.

Water jet devices (i.e. a device having a nozzle for spraying liquid) in sanitary and bath products are often used to spray water and to clean parts of the body. Water jet devices may be connected to bidets or intelligent toilets (e.g. having a bidet feature). Conventional water jet devices are powered for a telescoping movement by a drive assembly having a motor. The motor in the drive assembly is often small, and not capable of providing a large amount of torque for the telescoping feature of the water jet device. It is challenging and difficult to develop small drive assemblies capable of providing such torque.

### SUMMARY OF THE INVENTION

An embodiment of the present disclosure relates to a drive assembly for a telescoping wand of water jet device. The drive assembly includes an internally engaged rotary disk. With rotation of the internally engaged rotary disk, the telescoping wand of the water jet device is caused to retract or expand. This configuration can advantageously reduce the size of the gearing required to drive the telescoping feature while still providing sufficient torque.

A drive assembly for a telescoping water jet device includes a motor configured to drive a pinion disk via a gearing system. The assembly further includes an internally engaged rotary disk having internal teeth. The internally engaged rotary disk and the pinion disk are located such that the pinion disk engages with the internal teeth of the internally engaged rotary disk. The pinion disk provides rotational torque from the motor to the internally engaged rotary disk. The internally engaged rotary disk is coupled to the telescoping feature such that rotation of the internally engaged rotary disk controllably extends or retracts the telescoping feature. The assembly may include a motor shaft connected to the motor. The assembly may further include motor gears fixed on the motor shaft, the motor gears configured to engage with a gearwheel disk of the gearing system. The gearwheel disk and the pinion disk may be coaxially and fixedly connected. The gearwheel disk and the pinion disk may be integrally formed.

Another embodiment of the present disclosure relates to a drive assembly for a water jet device. The drive assembly includes a motor having a side face and configured to drive a gearwheel disk, and an internally engaged rotary disk having internal teeth. The drive assembly also includes a fixed shaft positioned at the approximate center of the internally engaged rotary disk. The fixed shaft is configured to provide an axis for the internally engaged rotary disk. Connecting gear of the assembly may include a pinion disk configured to engage with the internal teeth of the internally engaged rotary disk. The pinion disk may therefore drive the internally engaged rotary disk to rotate around the fixed shaft. The gearwheel disk and/or a system of intermediate gears may be configured to drive the pinion disk. The drive assembly provides power to a telescoping feature of a water jet device.

Another embodiment of the present disclosure relates to a water jet device having a drive assembly. The water jet device includes a body, which includes a nozzle having a plurality of water jet holes, at least one tube section, and a base. The water jet device also includes a drive assembly. The drive assembly includes a motor having a side face and is configured to drive a gearwheel disk. The drive assembly further includes an internally engaged rotary disk having internal teeth and a fixed shaft positioned at the approximate center of the internally engaged rotary disk. The fixed shaft is configured to provide an axis for the internally engaged rotary disk. The drive assembly may include connecting gear between the gearwheel disk and the internally engaged rotary disk. The connecting gear may include a pinion disk configured to engage with the internal teeth of the internally engaged rotary disk. Driving rotation of the pinion disk drives the internally engaged rotary disk to rotate around the fixed shaft.

In this embodiment, the water jet device also includes a steel strip (or a strip of other material) having two ends, a first end of the steel strip being coupled to at least one telescoping tube section of a bidet wand. A second end of the steel strip is coupled (for being pushed or pulled by) the internally engaged rotary disk. The steel strip is configured to move at least one tube section as the internally engaged rotary disk rotates. In this embodiment, the drive assembly provides mechanical power to the telescoping feature of the water jet device.

Another embodiment of the present disclosure relates to a method for providing a water jet device (e.g., telescoping bidet wand) having a drive assembly. The method includes providing a body (e.g., for the bidet wand). The body includes a nozzle (e.g., bidet nozzle) having a plurality of water jet holes, at least one telescoping tube section, and a base. The method also includes providing a drive assembly for the telescoping tube section. The drive assembly includes a motor having a side face and configured to drive a gearwheel disk. The drive assembly further includes an internally engaged rotary disk having internal teeth and a fixed shaft positioned at the approximate center of the internally engaged rotary disk. The fixed shaft is configured to provide an axis for the internally engaged rotary disk. The drive assembly further includes one or more connecting gear. The connecting gear includes a pinion disk configured to engage with the internal teeth of the internally engaged rotary disk. The motor can drive the internally engaged rotary disk to rotate around the fixed shaft via the gearwheel disk and the pinion disk, wherein the gearwheel disk is configured to drive the pinion disk.

In this embodiment, the method can also include providing a strip (e.g., steel, plastic, etc.) having two ends, a first end of the strip being coupled to at least one tube section, a second end of the strip being coupled for movement with the internally engaged rotary disk. When the internally engaged rotary disk rotates, the strip moves laterally and causes the at least one tube section to telescope (i.e., expand or retract, depending on the direction of the rotation of the internally engaged rotary disk).

### BRIEF DESCRIPTION OF THE FIGURES

FIG. 1A is a perspective view of a conventional water jet device as viewed from one direction.

FIG. 1B is a perspective view of the conventional water jet device of FIG. 1A, as viewed from another direction.

FIG. 1C is a partial exploded view of the conventional water jet device of FIG. 1A.

FIG. 2 is a perspective view of the water jet device of the present disclosure, according to an exemplary embodiment.

FIG. 3 is a partial exploded view of the water jet device of the present disclosure, according to an exemplary embodiment.

FIG. 4 is a partial exploded view of the water jet device of the present disclosure, according to an exemplary embodiment.

FIG. 5 is a structural schematic diagram of the water jet device of the present disclosure, wherein a motor and a connecting gear have been assembled.

FIG. 6 is a cross-sectional view of the water jet device of the present disclosure, according to an exemplary embodiment.

FIG. 7 is a cross-sectional view of the water jet device of the present disclosure, according to an exemplary embodiment.

FIG. 8A is a top view of the conventional water jet device of FIGS. 1A-1C.

FIG. 8B is a top view of the water jet device of the present disclosure, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

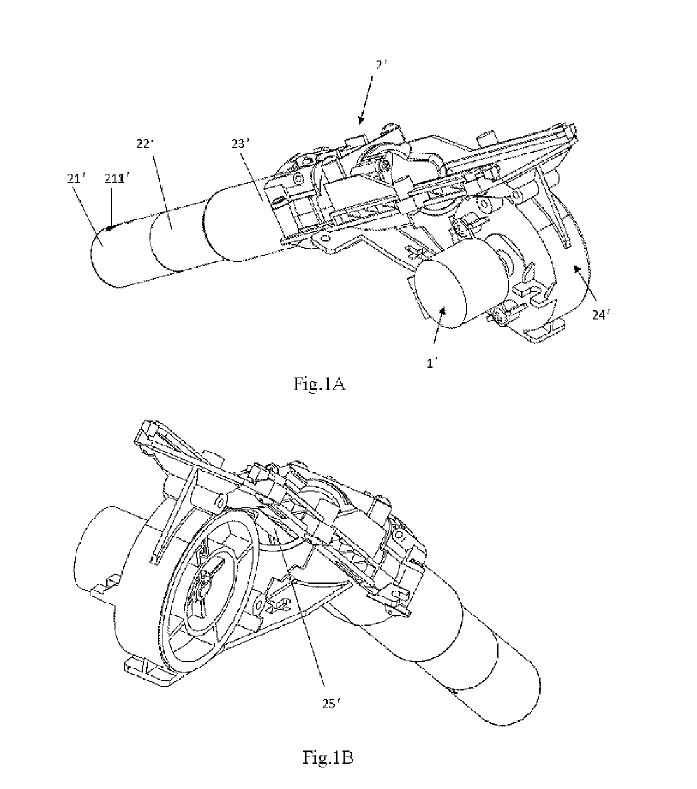

Referring to FIGS. 1A-1C, a conventional water jet device is shown. The conventional water jet device includes a stepper motor 1′ and a water jet body 2′. The stepper motor 1′ supplies power to allow the water jet device to telescope (i.e. to allow the nozzle 21′ to contract toward the water jet body 2′). The stepper motor 1′ includes a motor body 11′ and a connecting post 12′. The end 121′ of the connecting post 12′ is designed to be non-circular in shape. In this way, the end 121′ and a rotary disk opening 242′ are arranged without relative rotation, and the driving post 12′ is configured to drive a rotary disk 241′ to rotate. The motor body 11′ includes a power source and a gear reduction mechanism. The torque output by the power source is amplified to some extent via the gear reduction mechanism and then outputted onto the driving post 12′ of the motor 1′.

Still referring to the conventional water jet device illustrated in FIGS. 1A-1C, the water jet body 2′ includes a nozzle 21′, a first tube section 22′, a second tube section 23′ and a base 24′. The nozzle 21′ is a hollow cylinder with an opening on the end of the cylinder. The nozzle includes several small holes 211′ on one side of the cylinder that are configured to spray water. The water is intended to be used to clean parts of the body. The inner diameter of the first tube section 22′ is smaller than that of the second tube section 23′, and the first tube section 22′ is configured to slide within the second tube section 23′. Thus, the first tube section 22′ may be disposed within the second tube section 23′, and may have telescopic motion in relation to the second tube section 23′. The nozzle 21′ is sleeved on the first tube section 22′. Both the first tube section 22′ and the second tube section 23′ include internal pipelines configured to have water flowing through the tube.

According to the conventional water jet device shown in FIGS. 1A-1C, one end of a steel strip 25′ or other elongated member may be fixed at the edge of the first tube section 22′ (e.g., a telescoping piece of a bidet wand) by screws or another connecting mechanism. The other end of the steel strip 25′ is connected to the water jet device by a rotary disk 241′. The steel strip 25′ may cause the first tube section 22′ to “telescope,” pulling the first tube section 22′ into the second tube section 23′ when the rotary disk 241′ rotates. After the first tube section 22′ fully enters the second tube section 23′ by the pulling force of the steel strip 25′, the second tube section 23′ may be retracted further into the base 24′ until the nozzle 21′ is fully disposed within the base 24′. The side of the base 24′ that faces the rotary disk 241′ (according to FIGS. 1A-1C) includes an opening to accommodate the rotary disk 241′. The bottom surface at the base 24′ end is a circular ring 243′ with certain thickness. The thickness of the circular ring 243′ is approximately equivalent to that of a drive block 244′ of the rotary disk 241′.

In this conventional water jet device, the rotary disk 241′ is a flat cylinder with openings at the top and bottom, and its shape aligns with that of the base 24′. The rotary disk 241′ may thus be disposed inside the base 24′, and is configured to engage with the base 24′, in order to rotate along with the motor 1′. The outer edge of the rotary disk 241′ extends radially and includes a side ring 245′ with a certain width. The rotary disk 241′ is arranged in this manner so that after the rotary disk 241′ is mounted into the base 24′, a space is formed between the outside face of the rotary disk 241′ and the inside face of the base 24′ to accommodate the steel strip 25′. A circular drive block 244′ is mounted in the approximate center of the rotary disk 241′, and the drive block 244′ is connected to the rotary disk 241′ at multiple points. The drive block 244′ is connected to the rotary disk 241′, such that the drive block 244′ may force the rotary disk 241′ to rotate.

When the rotary disk 241′ is disposed within the base 24′, the drive block 244′ likewise enters the circular ring 243′ of the base 24′. The inside face of the circular ring 243′ then contacts the outside face of the drive block 244′. An opening 242′ is arranged at the approximate center of the drive block 244′, and the shape of the opening 242′ corresponds to the shape of the driving post 12′ of the stepper motor 1′. To prevent rotation of the driving post 12′ relative to the opening 242′, the shape is not circular. After the driving post 12′ of the stepper motor 1′ is inserted into the opening 242′ of the drive block 244′, the rotary disk 241′ may be driven to rotate. The steel strip 25′ that is connected to the rotary disk 241′ is configured to controllably force the first tube section 22′ to move in a telescopic fashion.

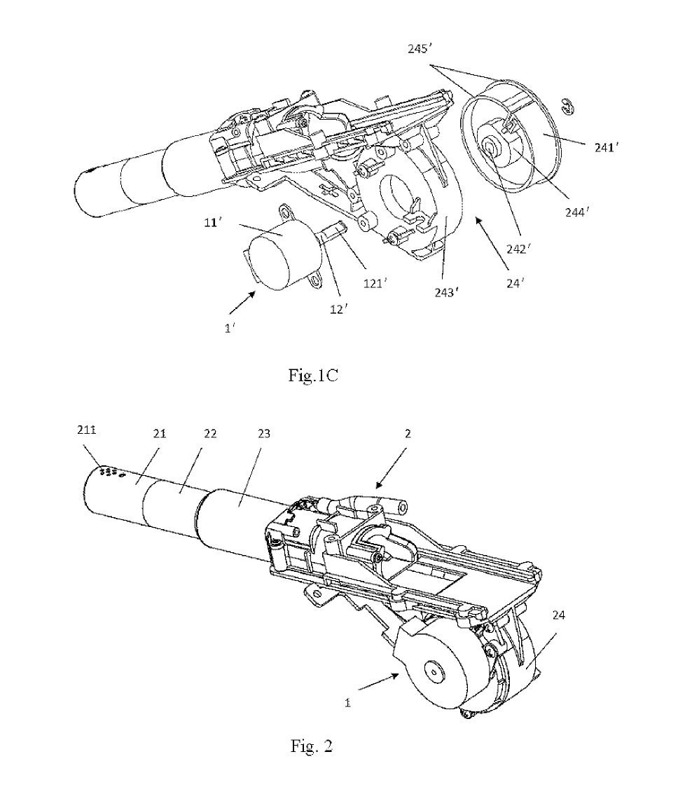

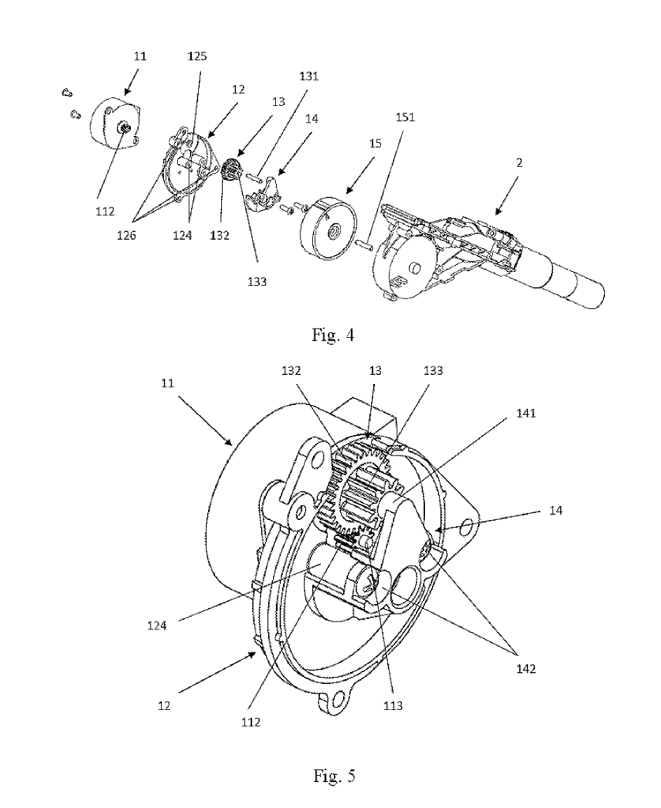

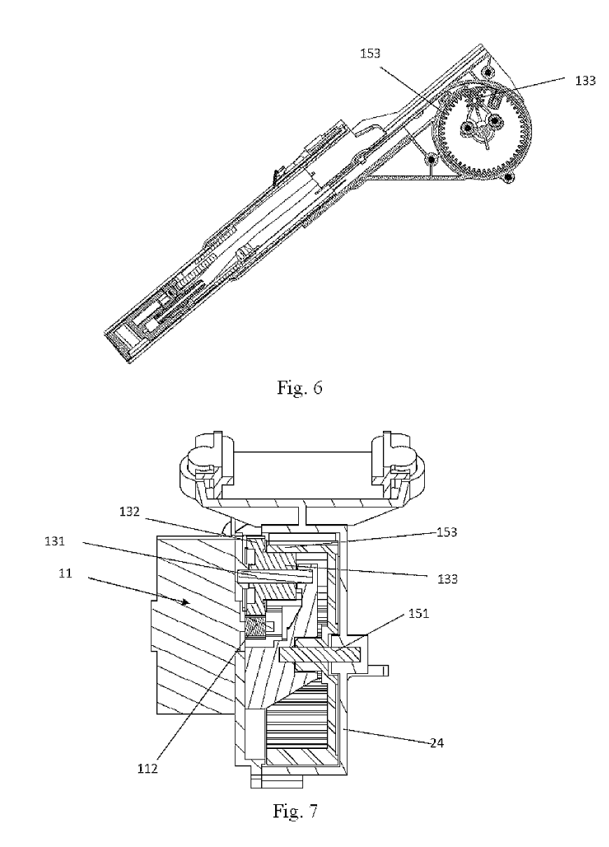

Referring now to FIGS. 2 to 7, a water jet device of the present disclosure is shown, according to an exemplary embodiment. In this embodiment, the water jet device includes a body 2, a drive assembly 1, and a steel strip (e.g., as shown in FIGS. 1A-1C) for connecting the effuser body 2 and the drive assembly 1. The body 2 includes a nozzle 21, a first tube section 22, a second tube section 23, and a base 24. The nozzle 21 includes a plurality of water jet holes 211. The first tube section 22 is disposed inside the second tube section 23, and is configured to move in and out of the second tube section 23, in a telescopic fashion.

In exemplary embodiments, the drive assembly 1 includes a motor 11, connecting gear 13 and an internally engaged rotary disk 15. The connecting gear 13 includes a gearwheel disk 132 and a pinion disk 133. The motor 11 is configured to drive the gearwheel disk 132, which is configured to drive the pinion disk 133 to rotate. The pinion disk 133 is configured to engage with internal teeth 153 of the internally engaged rotary disk 15. A fixed shaft 151 is positioned approximately at the center of the internally engaged rotary disk 15, and is configured to provide an axis for the rotary disk 15. The fixed shaft 151 is connected to the internally engaged rotary disk 15, and the internally engaged rotary disk 15 rotates around the axis. The rotary disk 15 thus may drive the steel strip to pull the tube sections 22 and 23 to move. In exemplary embodiments, one end of the steel strip is connected to the first tube section 22 and the other end of the steel strip is connected to the outside face of the fixed shaft 151. Thus, as the steel strip moves, the first tube section 22 may also move in a telescoping manner, e.g., in a direction toward or away from the water jet device body 2.

When the water jet device of the present disclosure is transitioning for non-use (i.e. when the first tube section 22 retracted within second tube section 23, and not spraying water), the motor 11 rotates and then drives the gearwheel disk 132 in the connecting gear 13 to rotate, in exemplary embodiments. In these embodiments, the gearwheel disk 132 may then drive the pinion disk 133 to rotate. The pinion disk 133 may be engaged by the internal teeth 153 of the rotary disk 15, transmitting power to the rotary disk 15. The rotary disk 15 may then rotate, pulling the steel strip mounted at the outside face of the rotary disk 15 to move. As the rotary disk 15 moves, the steel strip pulls the first tube section 22 toward the body 2, such that the first tube section 22 enters the second tube section 23. The second tube section 23 may be further driven to enter the base 24 until the nozzle 21 is fully disposed within the base 24.

On the other hand, when the water jet device transitioning for use (i.e. extending out from the body 2 and for spraying water), the motor 11 may rotate in the opposite direction from when the water jet device is not in use, in exemplary embodiments. In these embodiments, the fixed shaft 151 may push the steel strip, rather than pulling it, and the steel strip may push, pull or drag the first tube section 22 to extend towards the far end of the water jet device until the nozzle 21, the first tube section 22, and the second tube section 23 are stretched to their maximum length.

When the water jet device is in operation, in exemplary embodiments, the motor 11 may drive the gearwheel disk 132 in the connecting gear 13. In these embodiments, the speed of the motor 11 is reduced and the torque is increased through the use of multiple stages of gears. A motor shaft 113 is configured to mate with the gearwheel disk 132, as shown in FIG. 5. In exemplary embodiments, the radius of the motor shaft 113 is smaller than that of the gearwheel disk 132, so that the speed of the motor 11 may be reduced when the motor gears 112 of the motor shaft 113 drive the gearwheel disk 132. The revolutions of the motor shaft 113 drives fewer revolutions in the larger gearwheel disk 132, thus reducing the number of revolutions to a desired speed and obtaining a larger torque. If the torque is amplified, the motor 11 may achieve more of an amplification effect than that produced by the motor 11′ of the conventional water jet device of FIGS. 1A-1C. An external gear reduction mechanism that is driven by multistage gears may be mounted outside the motor 11, which will not be limited by the size of the motor 11. The gearwheel disk 132 and the pinion disk 133 coaxially rotate, thus the torque will not change during mutual transmission of the gearwheel disk 132 and the pinion disk 133.

In the illustrated exemplary embodiments, deceleration of the motor 11 may increase the output torque. In these embodiments, the output torque may advantageously be more than the torque outputted on the driving post 12′ by the stepper motor 1′ (e.g., via a gear reduction mechanism in the conventional water jet device). In exemplary embodiments, the pinion disk 133 further drives the internally engaged rotary disk 15 to rotate, thus pulling the steel strip. The arm of force is the sum of the radius of the pinion disk 133 and the gear thickness of the internally engaged rotary disk 15. This arm of force is less than the radius of the rotary disk 241′ of the conventional water jet device. The smaller radius may advantageously increase the force available to tangentially pull the steel strip, and may advantageously improves the telescopic reliability of the water jet device.

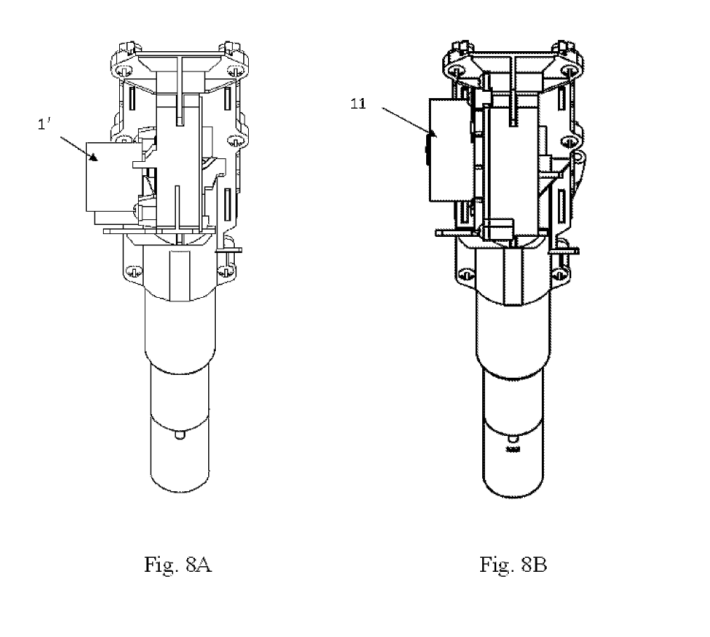

The water jet device of the present disclosure may advantageously allow the removal of the reducing mechanism in the motor 11, and therefore reduce the thickness of the motor 11 compared to the motor 11′ of the conventional water jet device. FIG. 8A shows a top view of the conventional water jet device, and FIG. 8B shows a top view of the water jet device of the present disclosure. FIGS. 8A and 8B show the difference in thickness between the conventional water jet device (FIG. 8A) and the water jet device of the present disclosure (FIG. 8B). The thickness of the water jet device in 8B is reduced by reducing the thickness of the motor 11, which may advantageously enable further bidet design flexibility and may make the water jet device of the present disclosure easier to accommodate.

In exemplary embodiments, motor gears 112 are fixed on the motor shaft 113 of the motor 11. The motor gears 112 are configured to engage with the gearwheel disk 132. The motor shaft 113 is coupled to the motor gears 112, which are then engaged with the gearwheel disk 132. The position of the connecting gear 13 is moved upward as compared to the conventional water jet device, thus the pinion disk 133 matches the internal teeth 153 of the internally engaged rotary disk 15.

In other exemplary embodiments, the gearwheel disk 132 and the pinion disk 133 are coaxially and fixedly connected. The gearwheel disk 132 and the pinion disk 133 also may be integrally formed in other exemplary embodiments.

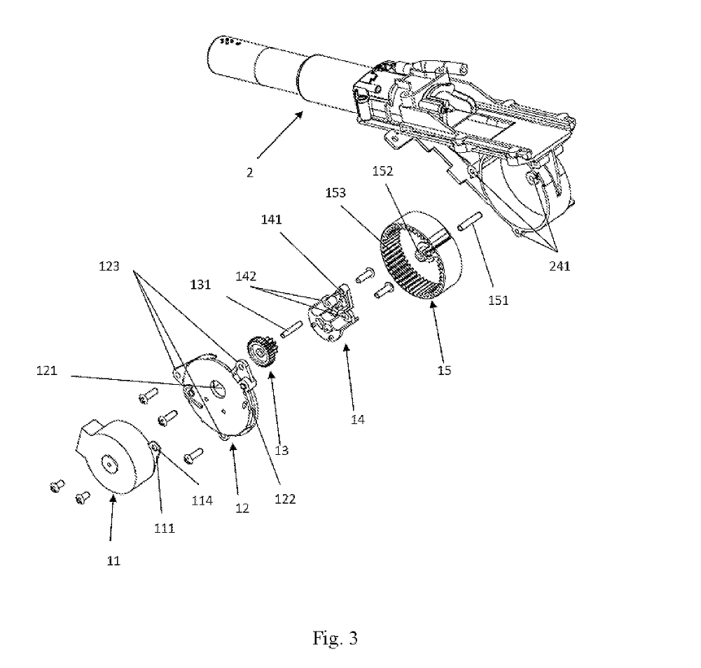

Referring now to FIG. 3, an exploded view of the drive assembly 1 of the present disclosure is shown, according to an exemplary embodiment. The side face of the motor 11 includes at least two first fixing plates 111 with a first bolt hole 114. The drive assembly 1 also includes a lamelliform (i.e. having the form of a thin plate) motor bracket 12 which is positioned between the motor 11 and the connecting gear 13, in this exemplary embodiment. The motor bracket 12 includes a fixing motor throughhole 122, which is configured to match the first bolt hole 114 and also includes a motor gear throughhole 121 for the motor gears 112 to pass through. The motor 11 is configured to fixedly connect the first bolt hole 114 to the fixing motor throughhole 122 by bolts, such that the motor 11 is fixed on the motor bracket 12. The motor gears 112 also pass through the motor gear throughhole 121 to match the connecting gear 13.

In exemplary embodiments, the number of first fixing plates 111 may be more than three, but may be any number suitable for the particular application. The number of fixing motor throughholes 122 may match that of the first bolt hole 114, but may also be any number suitable for the particular application.

In other exemplary embodiments, one side face on the motor bracket 12 that is facing the connecting gear 13 includes a first bolt post 124 and a first mounting hole 125 for mounting a connecting gear shaft 131. In these embodiments, the drive assembly 1 may also include a connecting gear bracket 14, configured to mount the connecting gear 13 onto the motor bracket 12. The connecting gear bracket 14 is positioned to face the connecting gear 13. The connecting gear bracket includes a second mounting hole 141 for mounting the connecting gear shaft 131, and a second bolt hole 142 configured to match the first bolt post 124. The connecting gear bracket 14 is configured to fix the connecting gear 13 onto the motor bracket 12 by mating the first bolt post 124 and the second bolt hole 142.

The connecting gear shaft 131 and the connecting gear 13 are also configured to fixedly connect, in exemplary embodiments. In these embodiments, the connecting gear shaft 131 passes through the connecting gear 13. One end is rotatably inserted into the first mounting hole 125 of the motor bracket 12, and the other end is rotatably inserted into the corresponding second mounting hole 141 of the connecting gear bracket 14. The connecting gear bracket 14 and the motor bracket 12 may be cooperatively clamped such that the connecting gear 13 is fixed between the motor bracket 12 and the connecting gear bracket 14, is engaged with the motor gears 112 in the motor 11, and can rotate along with the motor gears 112.

In other exemplary embodiments, the base 24 includes at least two second bolt posts 241. The side face of the motor bracket 12 includes a second fixing plate 123 with at least two third bolt holes 126, and the third bolt holes 126 are configured to mate to the second bolt posts 241 to mount the motor bracket 12 onto the base 24. By mating the third bolt holes 126 and the second bolt posts 241, the motor 11, the connecting gear 13 and the connecting gear bracket 14 assembled in the motor bracket 12 are fixedly coupled to the base 24. As shown in FIG. 7, the connecting gear 13 and the connecting gear bracket 14 may be received in the base 24. The water jet device of the present disclosure may have a more compact structure and a smaller mounting space than the conventional water jet device.

The water jet device of the present disclosure may be used in automatic toilets, but is not limited to that application, and may also be used for any other devices or products that need to spray liquid matter via a telescoping wand. Also, although the water jet device of the present disclosure is a structure with two tube sections, the water jet device may also include any other number of sections, including but not limited to a single tube section.

What is claimed is:

1. A drive assembly for a telescoping water jet device, comprising:
a motor configured to drive a pinion disk via a gearing system;
an internally engaged rotary disk having internal teeth;
wherein the internally engaged rotary disk and the pinion disk are located such that the pinion disk engages with the internal teeth of the internally engaged rotary disk, and wherein the pinion disk provides rotational torque from the motor to the internally engaged rotary disk, wherein the internally engaged rotary disk is coupled to the telescoping feature such that rotation of the internally engaged rotary disk controllably extends or retracts the telescoping feature.

2. The drive assembly of claim 1, further comprising:
a motor shaft connected to the motor; and
motor gears fixed on the motor shaft, the motor gears configured to engage with a gearwheel disk of the gearing system.

3. The drive assembly of claim 2, wherein the gearwheel disk and the pinion disk are coaxially and fixedly connected.

4. The drive assembly of claim 2, wherein the gearwheel disk and the pinion disk are integrally formed.

5. The drive assembly of claim 2, further comprising a lamelliform motor bracket positioned between the motor and connecting gear including the pinion disk, wherein a side face of the motor includes at least two first fixing plates, each having a first bolt hole, and wherein the motor bracket includes a fixing motor throughhole corresponding to the first bolt hole, and the motor gear bracket also includes a motor gear throughhole for the motor gears to pass through.

6. The drive assembly of claim 5, wherein the motor bracket includes at least one motor bracket side face, a first motor bracket side face including a first bolt post and a first mounting hole for mounting a connecting gear shaft.

7. The drive assembly of claim 6, further comprising a connecting gear bracket having at least one connecting gear bracket side face, and configured to mount the connecting gear onto the motor bracket, a first connecting gear bracket side face including a second mounting hole configured to mount the connecting gear shaft and a second bolt hole corresponding to the first bolt post.

8. A water jet device having a drive assembly, the water jet device comprising:
a body, comprising:
a nozzle having a plurality of water jet holes;
at least one tube section;
a base
a drive assembly, comprising:
a motor having a side face and configured to drive a gearwheel disk;
an internally engaged rotary disk having internal teeth;
a fixed shaft positioned at the approximate center of the internally engaged rotary disk, and configured to provide an axis for the internally engaged rotary disk;
connecting gear, comprising (a) a pinion disk configured to engage with the internal teeth of the internally engaged rotary disk, and to drive the internally engaged rotary disk to rotate around the fixed shaft and (b) the gearwheel disk configured to drive the pinion disk; and
a steel strip having two ends, a first end of the steel strip being coupled to at least one tube section, a second end of the steel strip being coupled to the internally engaged rotary disk, the steel strip configured to move at least one tube section as the internally engaged rotary disk rotates.

9. The water jet device of claim 8, further comprising a motor shaft connected to the motor, and motor gears fixed on the motor shaft, the motor gears configured to engage with the gearwheel disk.

10. The water jet device of claim 8, wherein the gearwheel disk and the pinion disk are coaxially and fixedly connected.

11. The water jet device of claim 8, wherein the gearwheel disk and the pinion disk are integrally formed.

12. The water jet device of claim 9, wherein the side face of the motor includes at least two first fixing plates, each having a first bolt hole, and the drive assembly includes a lamelliform motor bracket positioned between the motor and the connecting gear, and the motor bracket includes a fixing motor throughhole corresponding to the first bolt hole, and the motor bracket also includes a motor gear throughhole configured to permit motor gears to pass through.

13. The water jet device of claim 12, wherein the motor bracket includes at least one motor bracket side face, a first motor bracket side face including a first bolt post and a first mounting hole for mounting a connecting gear shaft.

14. The water jet device of claim 12, wherein the drive assembly includes a connecting gear bracket having at least one connecting gear bracket side face, and configured to mount the connecting gear onto the motor bracket, a first connecting gear bracket side face including a second mounting hole configured to mount the connecting gear shaft and a second bolt hole corresponding to the first bolt post.

15. The water jet device of claim 13, wherein the base includes at least two second bolt posts, the motor bracket side face includes a second fixing plate with at least two third bolt holes, and the third bolt holes correspond to the second bolt posts, and are configured to mount the motor bracket onto the base.

16. The water jet device of claim 8, wherein the body includes a first tube section and a second tube section, the first tube section configured to slide within the second tube section, the first tube section has telescopic motion relative to the second tube section, and the steel strip is configured to move the first tube section.

17. A method for providing a water jet device having a drive assembly, the method comprising:
providing a body, the body comprising:
a nozzle having a plurality of water jet holes;
at least one tube section;
a base
providing a drive assembly, the drive assembly comprising:
a motor having a side face and configured to drive a gearwheel disk;
an internally engaged rotary disk having internal teeth;
a fixed shaft positioned at the approximate center of the internally engaged rotary disk, and configured to provide an axis for the internally engaged rotary disk;
connecting gear, comprising:
a pinion disk configured to engage with the internal teeth of the internally engaged rotary disk, and to drive the internally engaged rotary disk to rotate around the fixed shaft;
a gearwheel disk configured to drive the pinion disk; and
providing a steel strip having two ends, a first end of the steel strip being coupled to at least one tube section, a second end of the steel strip being coupled to the internally engaged rotary disk, and moving at least one tube section by rotating the internally engaged rotary disk, thus moving the steel strip.

18. The method of claim 17, further comprising rotating the gearwheel disk by providing a motor shaft connected to the motor, and providing motor gears fixed on the motor shaft, the motor gears engaging with the gearwheel disk.

19. The method of claim 17, wherein the side face of the motor includes at least two first fixing plates, each having a first bolt hole, and the drive assembly includes a lamelliform motor bracket positioned between the motor and the connecting gear, and the motor bracket includes a fixing motor throughhole corresponding to the first bolt hole, and the motor bracket also includes a motor gear throughhole configured to permit motor gears to pass through.

20. The method of claim 17, wherein the body includes a first tube section and a second tube section, the first tube section sliding into the second tube section, the steel strip moving the first tube section in a telescopic motion relative to the second tube section.
